(19) United States
(12) Patent Application Publication
(10) Pub. No.: US 2008/0157411 A1
(43) Pub. Date: Jul. 3, 2008

(54) Device and Method for Humidifying an Air Flow

(76) Inventors: Martin Moritz, Berlin (DE); Hans Peters, Berlin (DE)

Correspondence Address: HENRY M FEIEREISEN, LLC, 350 FIFTH AVENUE, SUITE 4714, NEW YORK, NY, 10118, US

(21) Appl. No.: 11/910,363

(22) PCT Filed: Mar. 29, 2006
(86) PCT No.: PCT/EP2006/003029

§ 371 Date: Oct. 1, 2007

(30) Foreign Application Priority Data
Mar. 29, 2005 (EP) 05090076.0

(51) Int. Cl. B01F 3/04; F28C 3/02

(52) U.S. Cl. 261/128; 261/151

(57) ABSTRACT

The invention concerns a device for increasing the relative humidity of an air flow (13), comprising air humidifying means (25) which are arranged in the air flow (13), and which are configured to supply humidifying water to the air flow (13). The invention is characterized in that said air humidifying means (25) are connected to a humidifying circuit (5) which comprises a recycling pump (7) for recycling the humidifying water in the humidifying circuit (5), and a humidifying heat exchanger (13) for heating the humidifying water so that it reaches a temperature lower than boiling point. The invention aims at creating a device enabling the humidifying power to be significantly increased, at a low cost and with little space requirement. Therefor, the humidifying means include a hollow porous material (15) which is connected to the humidifying circuit (5).

This invention concerns a device for increasing the relative humidity of an air flow comprising humidifying means which are arranged in the air flow and which are configured to supply humidifying water to the air flow, wherein the humidifying means are connected to a humidifying circuit which comprises a circulating pump for circulating the humidifying water in the humidifying circuit, and a humidifying heat exchanger for heating the humidifying water below the boiling point.

This invention further relates to a method for humidifying an air flow, in which humidifying water is fed into the air flow, wherein the humidifying water is circulated in a humidifying water circuit under continuous heating, and in this way heated to a temperature of between 40 and 95 degrees Celsius.

Such device and such method are already known from DE 43 29 209 A1. There, a falling film evaporator is shown with a mechanism provided with trickle decks extending transversally to a rising air flow. In order to humidify the air flow, water is applied on the upper trickle deck by means of a water dispenser. The water subsequently flows like a cascade over the trickle decks through apertures in the trickle decks. Therefore, the water touches the air flow that is to be humidified. To improve the transition of the water from its fluid form into the vaporous phase, a humidifying circuit is further provided. The humidifying circuit comprises a circulating pump to circulate the humidifying water in the humidifying circuit, and a humidifying heat exchanger for heating the humidifying water below the boiling point.

To suit people's comfort requirements, it is further necessary, in ventilating interior rooms, to heat the external air more or less extensively depending on its temperature. The colder the external air in comparison with the desired room air temperature, the more the air must be heated.

By heating the air, however, its relative humidity will drop at the same time. Below approximately 30% of relative humidity, discomfort can be expected for the users in the ventilated rooms. It is necessary to additionally humidify the outdoor air or supply air each time the relative humidity in the ventilated rooms falls below the value required for people, or below a value required in ventilated rooms during e.g. an industrial production process.

DE 2 260 225 shows a device for humidifying air at an air conveying air conditioning unit whose humidifying means are designed as a pipe dispensing humidifying water. The pipe extends within an air heating unit. The humidifying water is discharged through holes provided for in the pipe and drips into the exothermic unit.

DE 37 28 730 describes a device which cannot be passed by an air flow. The said device is used for heating and humidifying the air and consists of two high capillary plate-like components capable of heat storage. One of these components is crossed by metal heating tubes which are provided with a liquid heating medium flowing through them. In the second component, boreholes are made that are filled with water which is to evaporate via the plate surface and thus to humidify the ambient air.

EP 0 092 527 describes a device for humidifying the air in recirculation unit heaters where, viewed in direction of the air flow, a cistern is installed behind an air heating unit, equipped with ducts through which the air can flow after it has been heated beforehand. The inner surfaces of the cisterns are partially fitted with panels of a porous material through which the warm air is to flow whilst absorbing water.

U.S. Pat. No. 2,110,268 is about a device for humidifying the air in ventilation appliances that are optionally operating with outdoor—or recirculating air as well as with heating of air, in which, viewed in direction of the air flow, a water dispensing unit is installed behind a pipe bundle heat exchanger, consisting of one or more chambers with walls made of a porous material. The water flows through the chambers, penetrates through the porous walls and humidifies the air passing by on the other side.

WO 02/095297 describes a device for humidifying the air in ventilation appliances consisting of a battery with lamellas arranged side by side, over which a mobile sliding carriage moves dropping water onto the lamellas, which is to evaporate after touching the lamellas and thus to humidify the ambient air. The described device is again installed, viewed in direction of the air flow, behind a pipe bundle heat exchanger for heating the air.

EP 0 092 527 A2 shows a heating radiator with humidifying means where the humidifying means comprise a porous material. The porous material increases the surface due to the capillary forces, where a transition of humidifying water into the air that is to be humidified, can take place.

GB 463,369 shows an air conditioning unit with a humidifying device, in which the humidifying device is provided with a cistern equipped with a cooling system in case of hot outside temperatures. This can be replaced by a heater in case of cold outside temperatures.

Furthermore, steam humidifying means are known in which the humidifying water for humidifying the air is fed into the air flow to be heated, in a vaporous state at temperatures above 100 degrees Celsius.

The aforementioned devices and methods for humidifying air reveal a number of disadvantages. For instance, some prior art devices are installed, viewed in direction of the air flow, directly behind air heaters, as, on the one hand, the air shows a higher humidity absorption capacity after heating and, on the other hand, more energy is to be abstracted from the heated air for evaporation of the humidifying water. In practice, however, it turns out that the water temperature directly at the interface between the humidifying water and the air that is to be humidified, is too low to achieve an adequate phase transition of the water from fluidity into the gaseous state. The flowing air which normally has a temperature of approx. 20-24° C. only, will cool down the humidifying water at the interface between water and air. Furthermore, the abstraction of evaporation heat leads to a cooling down of the humidifying water at said interface. Due to the water temperature at the interface between air and the humidifying water being low accordingly, only a minor phase transition from fluidity into the gaseous state takes place, and hence only little humidifying output is achieved through these humidifying systems. An increase in output is not possible. Furthermore, partly room-filling humidifying tracks are required to achieve a certain output.

In order to allow for sufficiently high humidification at even low heating of the air, the device named at the outset offers a humidifying circuit with a heat exchanger. The heat exchanger heats the humidifying water, which then facilitates improved humidification of the air. The heated humidifying water, however, will cool down rapidly after entering the air flow for the reasons mentioned above, so that the intended increase of the humidifying output turns out to be relatively low only. In order to avoid the entering of splash water that is carried along by the air flow, into the rooms that are to be humidified or into the downstream areas of an air conditioning unit, the device named at the outset will in addition be costly and room-filling in its construction.

It is an object of the invention to provide a device and a method of the type named at the outset, that allow for effective humidification with limited installation space in a cost-efficient manner, whilst the entering of splash water into downstream areas can be avoided in a reliable manner.

Further object of the invention is to enable air humidification independently of air heating, that is, to allow for air to be humidified even when no or only little heating of the air is required or possible. Furthermore, the device and method according to the invention is to allow for a closed loop control of the humidification output of the respective humidifiers.

The invention solves this problem with the device named at the outset which humidifying means comprise a hollow porous material that is connected to the humidifying circuit.

The invention solves this problem on the basis of the method named at the outset through the heated humidifying water being fed into a hollow porous material.

According to the invention, the humidifying circuit comprises a hollow porous material, with heated humidifying water flowing continuously and controllably inside through the porous material. Due to the continuous flow of heated water, heat energy is constantly supplied to the inside of the porous material, so that in the inside and due to the porosity of the humidifying means filled with water, a high temperature can be kept continuously even on the outside surface of the porous material. In case of appropriate porosity of the humidifying means, e.g., 1.9 μm of average pore size against an open porosity of 30%, the heated humidifying water can reach the outside surface of the humidifying means. Owing to the continuously high temperature on the outside surface of the porous material, a relatively easy phase transition of the humidifying water is achieved from fluidity into the gaseous phase, that is, high humidification output. Undesired splash water that would be carried along by the air flow, can in that way be avoided almost entirely.

The device according to the invention can be arranged in any air conditioning units and there in any place. It is thus possible, for instance, to arrange the device according to the invention within the cooling battery of an air-conditioning unit for space-saving reasons, where the device according to the invention can also be used for heating purposes along with humidification. Of course, a separate set-up of the device according to the invention without or outside other components is also conceivable, in which the combination of humidifying means with lamellas on the lines of heat exchangers for heating/cooling of air would be advantageous. In this case also it is possible to utilize the heated humidifying water for heating the air flow and thus for heating a room. During the warm seasons it is further possible to use the device according to the invention for cooling the air or the associated room, respectively, in which the humidifying heat exchanger acts as a cooler and cools down the water circulated in the humidifying circuit. Depending on the temperature of the water conducted through the humidifying means, dehumidification of the air can be achieved at the same time, if the temperature falls below the dew point of the air that is to be cooled down.

Heating and circuitry of the humidifying water allow for largely independent closed loop control of the air humidification, as control of the preheating of the humidifying water will lead to control of the air humidification as a result.

By means of the device and method according to the invention it is further possible to increase the output of air humidification in a particularly cost-efficient manner, as already existing installations of heat suppliers for air heaters can be used as a heat source.

Advantageously, in the operation of the device according to the invention, the temperature of the heated humidifying water is in the range of 40 and 95 degrees Celsius.

Pursuant to a preferred embodiment of the device according to the invention, the humidifying circuit comprises a control unit connected to the circulating pump and the humidifying heat exchanger, which controls the circulation speed, pressure and/or temperature of the humidifying water in the humidifying means. Control units are known as such, so that there is no need to elaborate further on their configuration in this context. A usual control unit thus comprises appropriate parameter sets, such as set point values for mass flow, temperature, pressure, or relative air humidity. The set point values are compared with metered values provided to the control unit through appropriate sensors. Depending on these parameters, a control routine system, for instance in the form of software programs, carries out certain control measures, such as increasing the delivery rate of the circulating pump.

Pursuant to a further embodiment of the invention, the humidifying circuit comprises control valves connected to the control unit. The control unit is therefore in a position to appropriately adjust, having access to the circulating pump and the control valves, both the temperature and the pressure and also the flow rate of the humidifying water in the humidifying means.

According to a preferred embodiment of the invention, the hollow porous material is a porous tube through which the humidifying water is driven under the effect of the circulating pump. In this the humidifying water permeates the porous wall of the tube towards the outside, depending on the pressure set, where it is then transferred into its vapor phase, for instance, via a heated air flow. In a respective further development, the hollow porous material will be in heat conducting contact with a heating element of an air heating heater or air heating unit.

Advantageously, the humidifying means are provided with a hydrophilic surface.

At variance to this and in addition to the hollow hydrophilic and/or porous material, the humidifying means comprise a perforated material or a material provided with apertures. The humidifying water is then discharged through the apertures.

Advantageously, the humidifying circuit can be connected to a water supply via a water treatment unit. The water treatment unit will serve for the removal of undesired substances dissolved in the humidifying water.

Appropriately, the humidifying means extend in an air heating unit which is provided with heating elements and through which an air flow can pass. The heating elements are set up independently of the humidifying heat exchanger, for example. In case of coupling of the heating elements with the humidifying heat exchanger, preheating of the humidifying water can be effected without heating the air flow passing through the heating elements. Thereby, for example, the inlet and the outlet of the heating elements can be connected with each other after the humidifying heat exchanger but before the inflow or discharge into the air heating unit. Alternatively, a valve, which is placed in the inlet or the outlet of the heating elements, may simply be closed. Based on a given heat energy, all ratios between heating and humidification can be established by means of respective control valves in the inlet or outlet of the heating elements and in the humidifying circuit.

According to a purposive further development in this regard, the humidifying heat exchanger will be coupled with an inlet of the air heating unit. In this way it is possible to achieve a particularly cost-efficient heating of the humidifying water, as there will be no more need for a separate and cost-intensive electrical power supply, in particular, for the heating. In this, the use of part of the heat energy designated for the air heater to heat the humidifying water, will not lead to an increase of the overall power requirement. This is because the heat energy consumed by heating the humidifying water, which comprises, for example, only a few percent in relation to the overall power requirement for the air conditioning (heating and humidification), will also be conducted via the humidifying water onto the air that is to be heated and humidified.

Advantageously, the heating elements are connected to a hollow hydrophilic and/or the porous material in a heat conducting manner. Thus the humidification output will be increased even further.

In another embodiment of the invention, the humidifying means comprise one or more humidifying tubes which extend within the air heating unit and which are provided with humidifying apertures to dispense the humidifying water. In this variant of the invention also, it has proved that the humidification output can be increased substantially by preheating the humidifying water.

Advantageously, the heat exchange unit and the air heating unit, in particular, comprise coatings of a material that facilitates evaporation. Such materials are, for instance, hydrophilic materials which produce a more effective surface moistening of the material that facilitates evaporation, in spite of the surface tension of the fluid humidifying water. The surface moistening will enlarge the specific water surface and will in this way facilitate or increase, respectively, the evaporation of the humidifying water. Apart from hydrophilic materials, materials with a large and, for instance, granular outer surface can also be considered in this context.

For an advantageous further development of the method according to the invention, the heated humidifying water will be fed into a hollow porous material. In doing so, the advantages mentioned earlier will be achieved.

For the reasons again described earlier, it has proved purposive to feed the heated humidifying water into a perforated material and/or one provided with holes.

It is also advantageous that the hollow porous material extends within an air heating unit having heating elements.

Advantageously, the heating elements heat the hollow porous material.

Further expedient refinements and advantages of the invention are the subject matter of the following description of exemplary embodiments of the invention, with reference to the figures of the drawing, in which parts having the same effect are provided with the same reference symbols, and in which

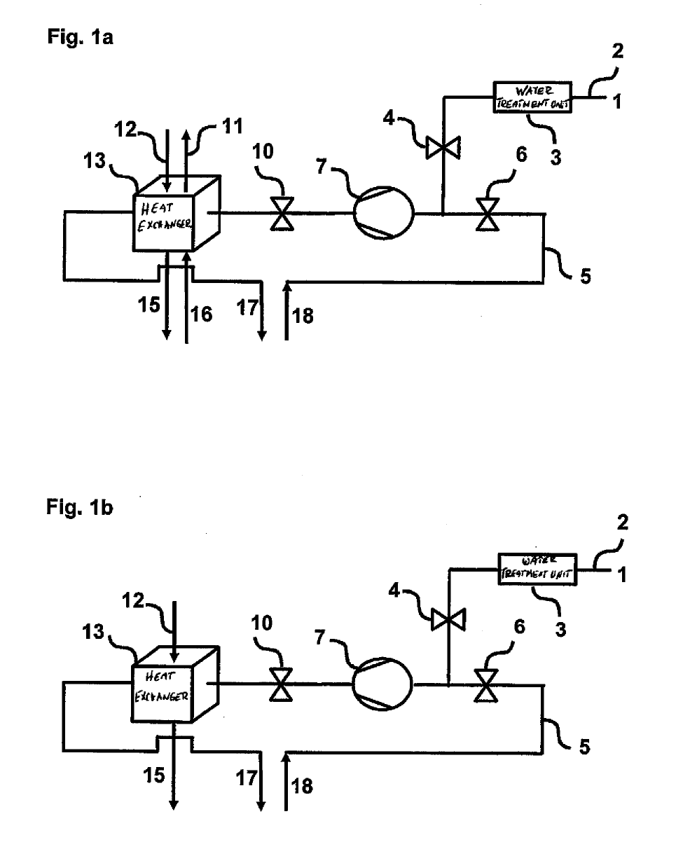

FIG. 1a is an illustrative embodiment of the device according to the invention, where the inlet and outlet of the heater circuit is directed through the humidifying heat exchanger,

FIG. 1b is a further illustrative embodiment of the device according to the invention, where only the flow of the heater circuit is directed through the heat exchanger,

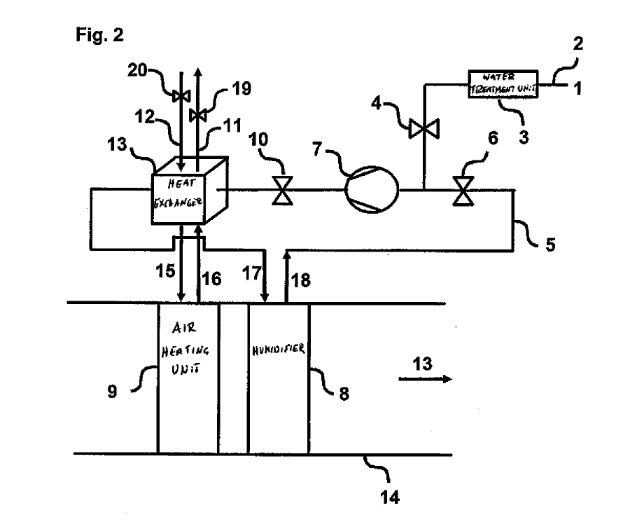

FIG. 2 is a device according to FIG. 1a with an air heater and humidifier, designed separately and represented schematically,

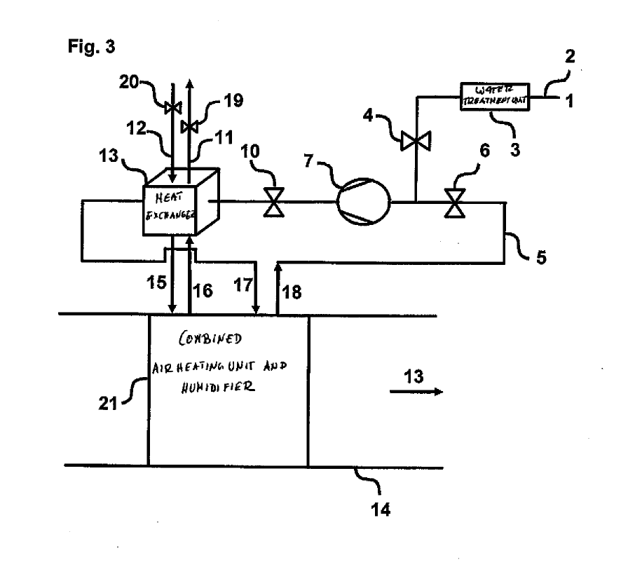

FIG. 3 is a device pursuant to FIG. 1a with an air heater and a humidifier, combined into a module represented schematically, and

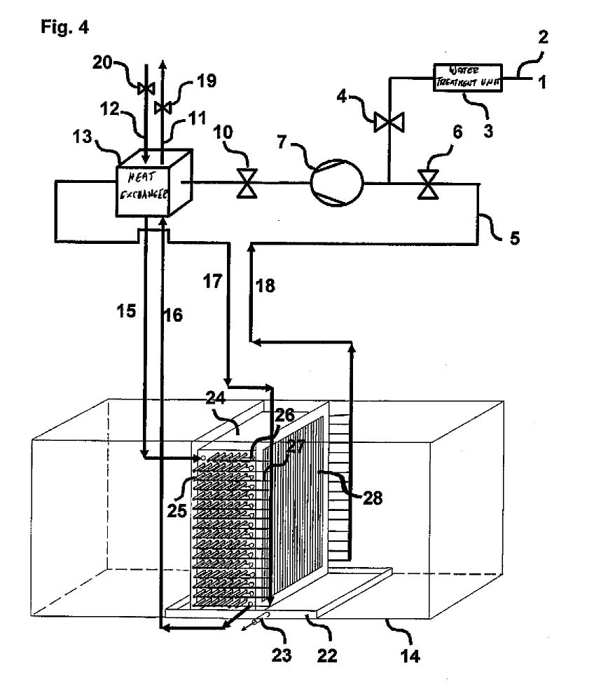

FIG. 4 is a device pursuant to FIG. 3 featuring an air heater and a humidifier, combined into a module represented more in detail.

FIG. 1a shows an exemplary embodiment of the device according to the invention. The device comprises a humidifying heat exchanger 13 which communicates with an inlet 12, 15 for the flow and an outlet 11, 26 for the return of an air heating unit, which is not represented in FIG. 1a. A heated liquid heating medium is directed through said inlet 12, 15 and is in this way fed into a heating element of the air heating unit, that is again not represented. The liquid heating medium of the inlet 12, 15 will be heated, for example, by heat from a so-called district heating network. At variance to this, it is also possible to apply another heat exchanger set up locally in order to facilitate heating of the heating element of the air heating unit.

The humidifying heat exchanger 13 is part of a humidifying circuit 5 which is further provided with a circulating pump 7 and control valves 6 and 10. The humidifying circuit 5 is connected to a humidifier, again not represented in FIG. 1a, via a humidifying inlet 17 and a humidifying outlet 18, by means of which the relative humidity of a humidifier permeating air flow can be increased. The operating mode of the humidifier will be described more in detail below.

The humidifying circuit 5 is connected via a water treatment unit 3 to an ordinary water supply 1, such as a municipal water pipe. A control valve 4 will again control the water supply.

Control valves 4, 6 and 10 and circulating pump 7 are connected to a control unit not represented in FIG. 1a, which is configured to control the flow through control valves 4, 6 and 10 and to adjust the pumping capacity of the circulating pump 7. The control unit is further connected to temperature and pressure sensors not represented in FIG. 1a. In this way, closed loop control of the pressure, temperature and flow rate of the humidifying water within the humidifying circuit 5 is provided. Control is effected depending on predetermined setting parameters and by means of a logic implemented in the control unit.

FIG. 1b shows another illustrative embodiment of the device according to the invention, in which, contrary to the illustrative embodiment shown in FIG. 1a, however, only the inlet 12, 15 for the flow of the air heating unit is directed through of the humidifying heat exchanger 13.

FIG. 2 shows a device pursuant to FIG. 1a with the said air heating unit 9 represented schematically. The air heating unit 9 is located within a canal-like casing 14 of an air conditioning unit. An air flow is directed though said casing 14, as indicated in the direction of the arrow. A humidifier 8 is connected downstream to the air heating unit 9 in the way of air flow 13, which communicates with the humidifying circuit via the inlet 17 or the outlet 18, respectively. The increase of relative humidity of the air flow heated by the air heating unit 9 will be facilitated through the heating of the humidifying water partly circulating within the humidifying circuit 5.

FIG. 3 shows another illustrative embodiment of the device pursuant to FIG. 2, in which, however, the air heating unit and the humidifier are combined into a joint combination unit 21 indicated schematically.

FIG. 4 shows the illustrative embodiment pursuant to FIG. 3 with the combination unit 24 represented in more detail. The combination unit 24 comprises elongated heat exchanger lamellas 28 aligned parallel to each other. Tubular heating elements 26 extend through the said heat exchanger lamellas 28 in transverse direction. In this, the heating elements 26 are in heat conducting contact with the heat exchanger lamellas 28 and are fed with a heated liquid heating medium via inlet 15. The liquid heating medium flows through the tubular heating elements 26. The heating elements 26 heat the heat exchanger lamellas 28 and thus heat the air flow 13 passing by the heat exchanger lamellas 28.

Between the heating elements 26, tubular humidifying means 25 can further be noticed. The tubular humidifying means equally extend through the heat exchanger lamellas 28 in transverse direction and are in heat conducting contact with these. The humidifying means 25 are connected to the humidifying circuit 5 via the inlet 17 and the outlet 18, and consist of a porous material. The humidifying water partly circulating in the tubular porous material permeates the wall of the porous material, depending on the pressure set by the control unit that is not represented, and will be transformed into its gaseous state without droplet formation through the heating occurring simultaneously.

A water drain pan 22 is placed underneath the combination unit 24 to collect the humidifying or condensation water, which is fitted with a water discharge nozzle 23 to drain off the water.

1.-16. (canceled)

17. A device for increasing the relative humidity of an air flow, said device comprising:
air humidifying means arranged within an air flow and configured to supply humidifying water to the air flow; and
a humidifying circuit connected to the air humidifying means and including a circulating pump for circulating humidifying water in the humidifying circuit, and a humidifying heat exchanger for heating humidifying water below a boiling point,
wherein the air humidifying means includes a hollow porous material which is connected to the humidifying circuit.

18. The device of claim 17, wherein the humidifying water heated by the heat exchanger has a temperature which ranges between 40 and 95° C. during operation.

19. The device of claim 17, wherein the humidifying circuit includes a control unit, connected to the circulating pump and the heat exchanger, for controlling a circulating speed, pressure and/or temperature of humidifying water in the air humidifying means.

20. The device of claim 19, wherein the humidifying circuit includes control valves which are connected to the control unit.

21. The device of claim 17, wherein the hollow porous material of the air humidifying means is implemented in the form of a perforated material or a material having apertures.

22. The device of claim 17, wherein the hollow porous material of the air humidifying means is implemented in the form of porous humidifying tubes.

23. The device of claim 21, wherein the hollow porous material of the air humidifying means is implemented in the form of porous humidifying tubes.

24. The device of claim 17, wherein the humidifying circuit is connected to a water supply via a water treatment unit.

25. The device of claim 24, further comprising an air heating unit having heating elements, said air humidifying means extending within the air heating unit through which the air flow passes.

26. The device of claim 21, further comprising an air heating unit having heating elements, said air humidifying means extending within the air heating unit through which the air flow passes.

27. The device of claim 25, wherein the air heating unit has at least one inlet coupled with the heat exchanger.

28. The device of claim 21, wherein the air heating unit has at least one inlet coupled with the heat exchanger.

29. The device of claim 23, wherein the air heating unit has at least one inlet coupled with the heat exchanger.

30. The device of claim 26, wherein the air heating unit has at least one inlet coupled with the heat exchanger.

31. The device of claim 25, wherein the heating elements are connected in a heat conducting manner to a hollow hydrophilic and/or porous material.

32. The device of claim 25, wherein the air humidifying means includes a humidifying tube extending within the air heating unit which is provided with humidifying apertures to dispense humidifying water.

33. The device of claim 25, wherein the air heating unit includes coatings of a material that facilitates evaporation.

34. The device of claim 26, wherein the air heating unit includes coatings of a material that facilitates evaporation.

35. The device of claim 32, wherein the air heating unit includes coatings of a material that facilitates evaporation.

36. A method for humidifying an air flow, comprising the steps of:
circulating humidifying water in a humidifying water circuit while continuously heated to a temperature ranging between 40° C. and 95° C.;
feeding heated humidifying water into a hollow porous material; and
exposing an air flow to heated humidifying water as the air flow passes the porous material.

37. The method of claim 36, wherein the heated water is also fed into an additional perforated material and/or material provided with holes.

38. The method of claim 36, further comprising the step of placing the hollow porous material within an air heating unit provided with heating elements.

39. The method of claim 38, wherein the hollow porous material is heated by the heating elements.
